(19) United States
(12) Patent Application Publication
(10) Pub. No.: US 2005/0210064 A1
(43) Pub. Date: Sep. 22, 2005

(54) Mobile terminal and method for remote control of a home gateway using same

(75) Inventors: Thierry Caldini, Pleumeur Bodou (FR); Gilbert Billon, Lannion (FR); Jean-Yves Lancien, Ploulec'h (FR)

Correspondence Address: OBLON, SPIVAK, MCCLELLAND, MAIER & NEUSTADT, P.C., 1940 DUKE STREET, ALEXANDRIA, VA, 22314, US

(73) Assignee: FRANCE TELECOM, Paris (FR)

(21) Appl. No.: 10/509,324

(22) PCT Filed: Apr. 4, 2003
(86) PCT No.: PCT/FR03/01070

§ 371 Date: Apr. 22, 2005

(30) Foreign Application Priority Data
Apr. 8, 2002 (FR) 02/04319

(51) Int. Cl. G06F 17/00

(52) U.S. Cl. 707/104.1

(57) ABSTRACT

The invention relates to a mobile multimedia terminal including a processor (11), a program memory (12), a data memory (13), and a voice-activated remote control device comprising a microphone (17), a voice recognition module (14), a lexical analyser (15) and a communication module (16) capable of controlling at least one item of household equipment (27) by means of a home gateway (21), via a wireless link (20), a manual input device, a screen (18) and a speaker (19). The invention also relates to a home gateway remote control method using a mobile multimedia terminal.

### FIELD OF THE INVENTION

The present invention relates to a mobile multimedia terminal and a home gateway remote control method using such a terminal.

### STATE OF THE RELATED ART

The use of a voice recognition module to control household equipment is known. However, this module is remote from the user. When transmitting an order between the user and said voice recognition module, the user must repeat the command when the audio, acoustic or electrical flux is subject to distortion. In addition, exchanges between the control device, which includes said voice recognition module, and the user are only carried out in voice mode. This results in tedious dialogue for the user.

The aim of the invention is to propose a terminal making it possible to resolve such a problem by reducing the risks of acoustic or electrical distortion of the audio flux and enabling the user to validate a voice command considered as ambiguous by the voice recognition module.

### DESCRIPTION OF THE INVENTION

The invention relates to a mobile multimedia terminal comprising a processor, a program memory and a data memory, comprising a voice-activated remote control device comprising a microphone, a voice recognition module, a lexical analyser, and a communication module, capable of controlling at least one item of household equipment by means of a home gateway, via a wireless link.

It may also comprise a manual input device, a screen and a speaker. The screen may be a screen equipped with touch input properties. The wireless link may for example be an IEEE 802.11 type link or a “Bluetooth” type link or any other type of radio transmission link supporting IP protocol.

The invention also relates to a remote control method of a home gateway connected to at least one item of household equipment via a home network, by means of a mobile multimedia terminal, comprising the following steps:
an actuation step of a terminal input peripheral by the user,
a transmission step of a voice command by said user,
a reception step of said voice command by the terminal,
a conversion step of the acoustic signal received into electrical information,
an analysis step of said electrical information and association of words described in a grammar,
a detection step of a correspondence between said words and a list of orders permitted by the home gateway,
a transmission step by the terminal of a warning that it has not been able to interpret an order,
a display step of an order if it exists,
a feedback step when the terminal has been able to interpret the order,
an encoding step of said order according to the gateway protocol,
an integration step of said encoded order into a transmission protocol request,
a transmission step of the request to the home gateway.

This method may also comprise a display step of a reiteration request message for the command in the event of ambiguity in its interpretation.

Advantageously, the method according to the invention comprises a control step of functions relating to at least one item of household equipment or intrinsic functions of the home gateway. In this way, it may comprise an actuation step of hardware or software processes hosted on at least one item of household equipment.

Advantageously, the method according to the invention comprises a command reiteration step, carried out in voice mode or by means of a manual action.

It is also possible to use an encryption algorithm of the information transmitted between the terminal and the home gateway.

The information transmitted between the terminal and the home gateway may be in IP format.

The mobile multimedia terminal according to the invention is thus capable of processing acoustic signals, including the result of the processing in IP packets, or any other protocol, transmitting this data in real time to a home gateway where it can be interpreted, and triggering any of the following actions:
control of equipment connected to said home gateway via a local data transmission network,
execution of predefined action scenarios to be carried out by said gateway,
internal notifications to said gateway,
equipment status request.

In return, said gateway may transmit to the mobile multimedia terminal information in the form of data, sound, image or video, indicating:
the command processing status,
notification of alarms and any events relating to the home local network or to equipment connected to said network.

### BRIEF DESCRIPTION OF FIGURES

FIG. 1 illustrates the architecture of the mobile multimedia terminal according to the invention.

FIG. 2 illustrates the steps of the method according to the invention.

### DETAILED DESCRIPTION OF PARTICULAR EMBODIMENTS

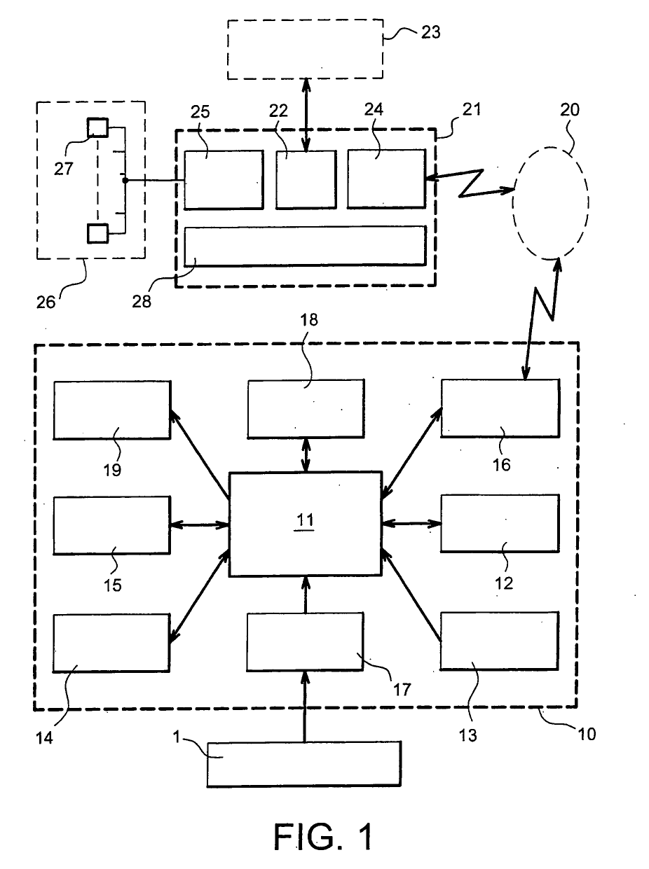

As represented in FIG. 1, the mobile multimedia terminal according to the invention 10, controllable by a local user 1, is a portable information system platform particularly incorporating the following functional components: a processor 11 to which a RAM memory 12, a bank memory 13, a voice recognition module 14, a lexical analyser 15, and a communication module 16 are connected, along with input and output peripherals.

The input peripherals may be a microphone 17, a manual input device which may consist of one or more push buttons. Said device may also comprise a screen 18 equipped with touch input properties.

The output peripherals may be such a screen 18 and a speaker 19.

As illustrated in FIG. 1, said terminal is connected via a wireless, IEEE 802.11, “Bluetooth” type link or any other link using a wireless communication standard (network 20), to a home gateway 21, which comprises:
an interface 22 with an external network 23,
an interface 24 with the internal network 20, for example, Hertzian,
an interface 25 with a home local network 26 comprising sensors or actuators 27 used to control household equipment, and multimedia equipment such as a Hi-fi or video system,
an interface 28 to the Internet.

Said terminal 10 is capable of transmitting digital information, for example in IP format, in real time to the home gateway 21 via its communication module 16.

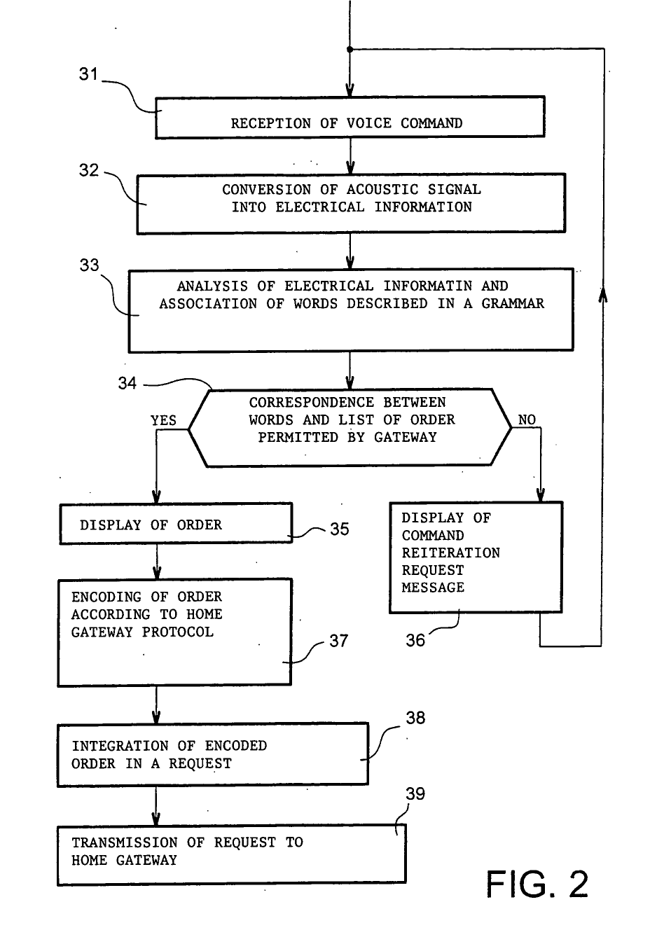

In the processing example illustrated in FIG. 2, following the transmission of a voice command from the user, it is received in the terminal using the microphone 17 (step 31). Said microphone 31 converts the acoustic signal into electrical information (step 32).

The voice recognition module 14 analyses this electrical information and associates, if applicable, words described in a grammar with it (step 33).

The lexical analyser 15 receives the words interpreted by the voice recognition module, locates a correspondence between said words and a list of orders permitted by the home gateway (step 34).

If the order belongs to the list of orders permitted by the gateway, the words recognised by said voice recognition module 14 are sent to the terminal screen (step 35). In the event of ambiguity in the interpretation, validation of the words displayed is requested from the user (step 36).

Following step 35, the lexical analyser 15 encodes the order according to the protocol of the gateway 21, before transmitting said information to the communication module (step 37).

The communication module 16 integrates the encoded order into a request, for example an “HTTP” request, of the transmission protocol, for example IP (step 38), and then transmits the request to the home gateway 21 via the wireless link 20 (step 39).

The mobile multimedia terminal according to the invention can thus be used for the remote actuation of hardware or software processes hosted on one or more items of equipment 27 of a home local network 26 connected to a home gateway 21.

This terminal 10 enables the user to voice-control all the remote control functions offered by the home gateway 21. Said functions may relate to equipment 27 connected to the home gateway 21 via the data network 26 or intrinsic to said gateway 21. An order from the user to an item to be controlled contains at least two useful items of information: an action and the name of the item.

The user may actuate any of the input peripherals of the mobile multimedia terminal 10, for example a push button on the terminal or an icon on the touch screen, before giving an order. This facility reduces risks of error to only the orders given by the user intended for the home gateway 21.

Advantageously, the terminal according to the invention 10 authorises the repetition of orders received and interpreted by the terminal 10 either visually on the screen 18, or by voice synthesis by the speaker 19. This feedback enables the user to validate or record orders. This feature facilitates the use of the remote control by blind or partially sighted users.

The mobile multimedia terminal 10 can warn the user when it has not been able to interpret an order received. This warning may be an audio or visual signal, or an audio message. In addition, the confirmation, repetition or reiteration of such an order may be performed by the user in voice mode or by means of a manual action, for example by pressing on a button or on the touch screen of the mobile multimedia terminal 10.

The mobile multimedia terminal 10 makes it possible to correct errors liable to result from Hertzian transmission. Methods well-known to those skilled in the art ensure the quality of service that can be used on the lower layers (“Bluetooth”, IEEE 802.11, etc.) and upper layers (TCP/IP, UDP/IP, etc.) of the transmission protocol. The lower layers are layers 1 and 2 of the OSI model: the Physical layer and Link layer. The upper layers are layers 3 to 6 of the OSI model, usually referred to as Network, Transport, Session and Presentation layers.

Finally, the mobile multimedia terminal 10 may comprise an encryption algorithm of the digital data contained in each IP packet so as to certify, render confidential and secure the message transmitted between said terminal and the gateway 21.

Said terminal 10 may, for example, be a digital PA or a larger format graphic tablet used to access home or family applications.

### EXAMPLE OF EMBODIMENT OF TERMINAL ACCORDING TO THE INVENTION

In an embodiment of the terminal 10, the oven and the roller blinds in a home are connected to the home gateway 21 and receive from said gateway via the home local network 26 the following parameters: start, stop, cooking stabilisation and gradient stages.

The user can thus, while sitting in the living room, use the voice-activated control of the terminal 10 to find out the progress of the cooking cycle and send an order to the oven to stop or reduce the temperature so as to delay the time at which the dish is removed from the oven.

From the same location, the user can control the closure of the blinds without missing any of their favourite television programme.

1-11. (canceled)

12. A mobile multimedia terminal comprising:
a processor;
a program memory;
a data memory;
a voice-activated remote control device including a microphone, a voice recognition module, a lexical analyzer, and a communication module configured to control plural items of equipment from a home local network by a home gateway, which comprises an interface with the home local network, by a wireless link, a manual input device, a screen, and a speaker.

13. A terminal according to claim 12, wherein the screen is equipped with touch input properties.

14. A terminal according to claim 12, wherein the wireless link is an IEEE 802.11 type link or a “Bluetooth” type link or any other type of radio transmission supporting IP protocol.

15. A terminal according to claim 12, enabling feedback when the terminal is configured to interpret a command order from one or more of the items of equipment.

16. A mobile multimedia terminal comprising:
a processor;
a program memory;
a data memory;
a voice-activated remote control device including a microphone, a voice recognition module, a lexical analyzer, and a communication module configured to control plural items of equipment from a home local network by a home gateway, which comprises an interface with the home local network, by an IEEE 802.11 type link or a “Bluetooth” type link or any other type of radio transmission link supporting IP protocol, a manual input device, a screen and a speaker, and also enabling feedback, when the terminal is configured to interpret a command order from one or more of the items of equipment.

17. A remote control method of a home gateway connected to at least one item of equipment by a home network, by a mobile multimedia terminal, the method comprising:
receiving an acoustic signal voice command by the terminal;
converting the received acoustic signal into electrical information;
analyzing the electrical information and associating words described in a grammar;
detecting a correspondence between the words and a list of orders permitted by the home gateway;
displaying an order if it exists;
encoding the order according to a gateway protocol;
integrating the encoded order into a transmission protocol request; and
transmitting the transmission protocol request to the home gateway.

18. A method according to claim 17, further comprising displaying a reiteration request message for the voice command in an event of an ambiguity in its interpretation.

19. A method according to claim 17, further comprising controlling functions relating to at least one item of household equipment or intrinsic functions of the home gateway.

20. A method according to claim 17, further comprising actuating hardware or software processes hosted on at least one item of household equipment.

21. A method according to claim 17, further comprising a command reiteration, carried out in a voice mode or by a manual action.

22. A method according to claim 17, wherein an encryption algorithm of the information transmitted between the terminal and the home gateway is used.

23. A method according to any of claim 17, wherein the information transmitted between the terminal and the home gateway is in IP format.

24. A remote control method of a home gateway connected to at least one item of equipment by a home network, by a mobile multimedia terminal, the method comprising:
receiving an acoustic signal voice command by the terminal;
converting the received acoustic signal into electrical information;
analyzing the electrical information and associating words described in a grammar;
detecting a correspondence between the words and a list of orders permitted by the home gateway;
displaying an order if it exists;
displaying a reiteration request message for the voice command and executing a command reiteration, carried out in a voice mode or by a manual action, in an event of ambiguity in an interpretation of the voice command;
encoding the order according to the gateway protocol;
integrating the encoded order into a transmission protocol request; and
transmitting the transmission protocol request to the home gateway.
